(19) United States
(12) Patent Application Publication
(10) Pub. No.: US 2016/0252409 A1
(43) Pub. Date: Sep. 1, 2016

(54) CALIBRATED TEMPERATURE SENSING SYSTEM

(71) Applicant: QUALCOMM, Incorporated, San Diego, CA (US)

(72) Inventors: Li Lu, San Diego, CA (US); Masoud Roham, San Diego, CA (US); Liang Dai, San Diego, CA (US); Anand Meruva, San Diego, CA (US)

(21) Appl. No.: 14/634,371

(22) Filed: Feb. 27, 2015

(51) Int. Cl. G01K 19/00; G01K 7/22

(52) U.S. Cl. CPC G01K 19/00; G01K 7/22

(57) ABSTRACT

Systems and methods for sensing temperature on a chip are described herein. In one aspect, a temperature sensing system includes a sensing circuit with matching diode devices for providing corresponding diode voltages proportional to currents through the diode devices. The system also includes a digital code calculation unit for generating a plurality of digital code values based on first and second reference voltages and the diode voltages and a digital calibration engine configured for computing a calibrated temperature based on the plurality of digital codes. The system further includes a switching circuit for routing the diode voltages, during first and second times, to diode voltage input terminals of the digital code calculation unit.

### BACKGROUND

1. Field

Aspects of the present disclosure relate generally to temperature sensing, and more particularly, to a calibrated temperature sensing system.

2. Background

A plurality of temperature sensors may be integrated on an integrated circuit chip and used to monitor temperature at various locations on the chip. Temperature readings from the sensors may be fed to a temperature management device that manages circuits (e.g., central processing unit (CPU)) on the chip based on the temperature readings. For example, the temperature management device may manage the circuits based on the temperature readings to prevent the temperature at one or more locations on the chip from becoming too high, which may degrade the performance or potentially damage the chip. In this example, if a temperature reading rises above a temperature threshold, the temperature management device may take action to reduce the temperature (e.g., reduce a frequency of a circuit).

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In first aspect, a temperature sensor is provided. The sensor includes at least one sensing unit including first and second matching diode devices for providing first and second diode voltages proportional to currents through the first and the second matching diode devices, respectively. The sensor also includes a digital code calculation unit including first and second diode voltage input terminals, where the digital code calculation unit configured for generating a plurality of digital code values based on first and second reference voltages and voltages at the first and the second diode voltage input terminals. The sensor further includes a first switching circuit configured for routing the first and the second diode voltages, during first times, to the first and the second diode voltage input terminals, respectively, and, routing the first and the second diode voltages, during second times, to the second and the first diode input voltage terminals, respectively. The sensor also includes a digital calibration engine configured for computing a calibrated temperature based on the plurality of digital codes.

In a second aspect, a method for sensing temperature is provided. The method includes providing first and second bias currents for first and second matching diode devices of a sensing unit according to a first input configuration during first times and according to a second input configuration during second times. The method also includes obtaining first and second diode voltages for the first and the second matching diode devices according to a first output configuration during first times and according to a second output configuration during second times. The method further includes generating a plurality of digital codes based on the first and the second diode voltages, during the first times and the second times, and first and second reference voltages, and computing a calibrated temperature based on the plurality of digital codes.

In a third aspect, an apparatus for sensing temperature is provided. The apparatus includes means for providing first and second bias currents for first and second matching diode devices of a sensing unit according to a first input configuration during first times and according to a second input configuration during second times. The apparatus also includes means for obtaining first and second diode voltages for the first and the second matching diode devices according to a first output configuration during first times and according to a second output configuration during second times. The apparatus further includes means generating a plurality of digital codes based on the first and the second diode voltages, during the first times and the second times, and first and second reference voltages, and means for computing a calibrated temperature based on the plurality of digital codes.

In a fourth aspect an integrated circuit is provided. The integrated circuit includes a plurality of sensing circuits, each of the plurality of sensing circuits including first and second matching diode devices and configured for providing first and second diode voltages proportional to current through the first and the second matching diode devices, respectively. The integrated circuit also includes a main module configured for selectively accessing any one of the plurality of sensing circuits to yield a selected sensing circuit. In the system, the main module includes a digital code calculation unit including first and second diode voltage input terminals and configured for generating a plurality of digital codes based on the first and the second diode voltages for the selected sensing circuit. The main module further includes a first switching circuit configured for routing the first and the second diode voltages for the selected sensing circuit to the first and the second diode voltage input terminals during first times, respectively, and for routing the first and the second diode voltages for the selected sensing circuit to the second and the first diode voltage input terminals during second times, respectively. The main module also includes a digital calibration engine configured for computing a calibrated temperature at the selected sensing circuit based on the plurality of digital codes.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows a temperature sensing system according to an aspect of the present disclosure.

FIG. 2 shows an integrated circuit including a temperature sensing system according to an aspect of the present disclosure.

FIG. 3 shows a temperature sensing system according to an aspect of the present disclosure.

FIG. 4 shows a method of temperature sensing according to an aspect of the present disclosure.

FIG. 5 shows a table comparing the effects of providing mismatch and process correction on temperature measurements performed according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

A plurality of temperature sensors may be incorporated into an integrated circuit chip and used to monitor temperature at various locations on the chip. Temperature readings from the sensors may be fed to a temperature management device that manages circuits (e.g., central processing unit (CPU), graphics processing unit (GPU), modem, etc.) on the chip based on the temperature readings. For example, the temperature management device may manage the circuits based on the temperature readings to prevent the temperature at one or more locations on the chip from becoming too high, which may degrade the performance or potentially damage the chip. In this example, if a temperature reading rises above a temperature threshold, then the temperature management device may take steps to reduce the temperature (e.g., reduce a frequency and/or supply voltage of a circuit).

Semiconductor bandgap temperature sensors may be used to measure temperature on a chip. Such sensors may be used for temperature measurement since the forward-biased voltage of a diode is temperature dependent. Thus, by biasing two diodes at the same temperature to have different forward currents and comparing the resulting two diode voltages, a simple relationship between the measured voltages, the currents, and temperature may be obtained. In the cases where one current is N times the other current and N is an integer >1, the voltage difference may be expressed as a function of temperature and N. Thus, the voltage difference between the two diodes may be proportional to absolute temperature (PTAT) and thus the voltage difference provides a PTAT signal. For example, one type of semiconductor bandgap temperature sensor that uses PTAT signals to obtain temperature is a bipolar junction transistor (BJT)-based temperature sensor. A BJT-based temperature sensor may comprise two BJTs, in which the ratio of the currents of the BJTs is fixed and a temperature reading may be generated directly from the base-emitter voltages of the BJTs.

The error of a semiconductor bandgap temperature sensor at a particular temperature (90 C for instance) may come from two sources: (1) The slope error of the temperature sensor circuit and (2) The error introduced by calibration. As to (1), the impact of this type of error may be reduced by circuit design to about +/−1 C˜1.5 C. However, as to (2), the reference temperature for calibration has limited accuracy and may be difficult to manage in some cases. In particular, calibration may be difficult as device dimensions on the integrated circuit are reduced, such as in new semiconductor process nodes.

For example, in older integrated circuit technologies, such as 28 nm or 20 nm semiconductor process nodes, calibration of corresponding BJT-based temperature sensors may not be problematic, as the amounts of process variation and mismatch observed at such process nodes may be insufficient to cause significant changes in the PTAT signals relied upon for temperature measurement. Thus, at 28 nm and 20 nm semiconductor process nodes, the amount of error observed in the PTAT signals may be as low as ±0.5° C. By using the PTAT signals as calibration reference, the temperature sensor measurement error after calibration is dominated only by the slope error. However, for newer technologies, such as 16 nm, 14 nm, or smaller semiconductor process nodes, process variation and mismatch significantly increase. As a result, the amount of error observed in the PTAT signals may be as high as ±5° C., a tenfold increase. This error may be even worse as smaller semiconductor nodes are used. Therefore, the temperature sensor measurement error after calibration is dominated by the calibration reference error and can be high.

As a result of the potential amount of error, it may be difficult to accurately identify a hot spot in an integrated circuit or portions thereof. In some cases, a portion of an integrated circuit may incorrectly indicate a hot spot exceeding an acceptable temperature, even when the actual temperature is in an acceptable range. Even worse, a portion of the integrated circuit may incorrectly read as being in an acceptable range, even though a hot spot exceeding the acceptable temperature actually exists. Consequently, to account for such measurement error, processes that rely on such temperature measurements are forced to control the measured temperature more closely to avoid adversely affecting the processes themselves.

For example, if a process is permissible over a range of absolute temperatures and a substantially small measurement error is present in the measured temperature, the measured temperature will remain at or close the actual temperature. Thus, variations in the measured temperature are not likely to result in variations in actual temperature falling outside the permissible range. In contrast, when the measurement error is large, there is a possibility that the measured temperature and the actual temperature are significantly different. As a result, variations in the measured temperature are more likely to result in variations in actual temperature falling outside the permissible range. Consequently, greater control of the measured temperature would be required, resulting in increased complexity of the process.

As noted above, a thermal management system may operate by comparing a sensed temperature to a threshold value. If the threshold value is met or exceeded, the thermal management system takes necessary action to reduce heat generation. However, the threshold value may be a conservative value to account for errors in the temperature measurement. For example, if 90° C. is the actual threshold temperature, 89° C. may be used by the thermal management system if the temperature sensors have an error of 0.5°-1.0° C. at 90 C. Thus, in this example, a 1° C. “safety guardband” is added due to the temperature sensor error. However, as the temperature sensor error increases, so must the safety guardband. For example, for a ±5° C. error, a 5° C. guardband would be implemented. Consequently, there may be reduced performance for the integrated circuit, as the thermal management system may force the integrated circuit to run at temperatures that are much cooler than necessary. Accordingly, improved accuracy of bandgap temperature sensors for smaller semiconductor process nodes is desirable.

The high error in the PTAT signals may be due to the diodes' process variation and mismatch. This high error may be reduced by a combination of error correction techniques. The mismatch error can be minimized by use of a dynamic element matching, which will be explained below in further detail. The remaining process variation in the PTAT signals shows strong correlation with the process variation of the bandgap voltage (V_{BG}), which is a combination of the PTAT signal and one of the diode voltages. However, V_{BG} is temperature insensitive and is therefore easy to measure in an environment with lower temperature control. Therefore, the correlation can be used to correct the PTAT signal and further reduce the error in the PTAT signals. The process variation error correction will be explained below in further detail.

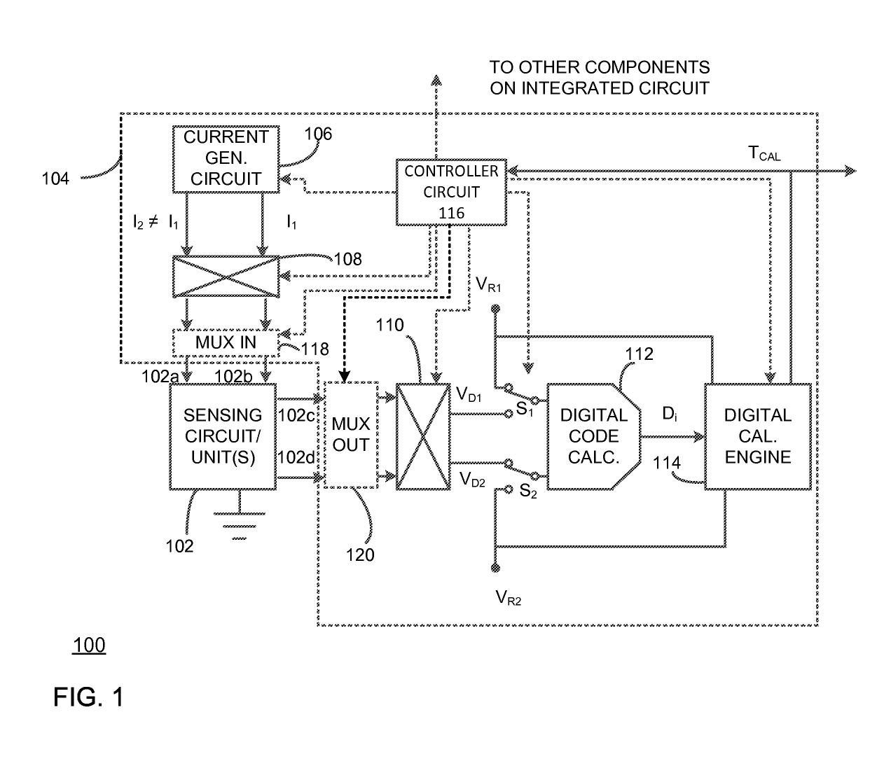

FIG. 1 shows a bandgap temperature sensor (BTS) system 100 according to an embodiment of the present disclosure. The BTS system 100 includes a main module 104 and at least one sensing circuit 102. The BTS system 100 may be implemented on an integrated circuit chip, as discussed in further detail below.

In BTS system 100, each sensing circuit 102 includes a pair of matched diode devices (not shown), input terminals 102a, 102b, and output terminals 102c, 102d. As used herein, the term “diode device” refers to any type of device incorporating a semiconductor diode, such as PN junction diode device or a BJT. However, a diode device is not limited to only such devices and may encompass any other types of devices including at least one semiconductor diode. Further, as used herein with respect to any types of diode devices, the term “matched” refers to diode devices designed to have the same or similar physical and operational characteristics. That is, the physical and operational characteristics within 20% of each other.

In operation, bias currents for the first and the second diode devices are received via input terminals 102a, 102b. In response to the bias currents, diode voltages for each of the pair of diode devices are provided at output terminals 102c, 102d. The sensing circuit 102 is configured such that the diode voltages at output terminals 102c, 102d are a function of the current through the semiconductor diode of an associated one of the pair of diode devices. In one aspect, the diode voltages are proportional to the current.

The sensing circuit 102 is coupled to the main module 104. The main module 104 comprises various components configured to provide the necessary bias currents for the sensing circuit 102, to calculate, based on the diode voltages from the sensing circuit 102, one or more signals representing a calibrated temperature at the sensing circuit 102, and, if necessary, generate control signals for other components

The main module 104 may include a current generating circuit 106. The current generating circuit 106 generates the bias currents for the sensing circuit 102. In one aspect, the current generating circuit 106 may generate a first bias current I₁ and a second bias current I₂, different from I₁. However, in another aspect, I₂ may be configured to be a multiple of I₁, i.e., I₂=M×I₁. As noted above, such a configuration may be used to simplify the necessary calculations. To generate the bias current, the current generating circuit 106 may be configured in a variety of ways. In one aspect, current generating circuit 106 may include different current sources for each of the bias currents. According to this aspect, any types of current sources may be used. In another aspect, a current mirror configuration may be utilized to generate the two currents. For example, in a current mirror providing M+1 currents, M currents may be combined to provide one bias current and the remaining current may provide the other bias current. Thus bias currents related by I₂=M×I₁ may be provided. However, any combinations of such currents may be used.

The current generating circuit 106 may be coupled to the input terminals 102a, 102b of sensing circuit 102 via first switching element 108, such as a dynamic matching element. The first switching element 108 may be configured to selectively route the bias currents I₁, I₂ from the current generating circuit 106 to the input terminals 102a, 102b. In particular, the first switching element 108 may be configured to provide a first input configuration and a second input configuration for routing currents to the input terminals 102a, 102b of the sensing circuit 102. In the first input configuration, bias current I₁ is routed to input terminal 102a and bias current I₂ is provided at input terminal 102b. In the second input configuration, bias current I₁ is routed to input terminal 102b and bias current I₂ is provided at input terminal 102a.

Similarly, a second switching element 110, such as a dynamic matching elements, may be provided in main module 104 to route the signals from the output terminals 102c, 102d to components within main module. Thus, the second switching element 110 may be configured to selectively route diode voltages at output terminals 102c, 102d from the sensing circuit 102 to diode voltage input terminals V_{D1}, V_{D2} of a digital code calculation unit 112. In particular, the second switching element 110, similar to first switching element 108, may be configured to provide a first output configuration and a second output configuration for providing diode voltages to the diode voltage input terminals V_{D1}, V_{D2}. In the first configuration, the diode voltage at output terminal 102c is routed to V_{D1} and the diode voltage at output terminal 102d is routed to V_{D2}. In the second configuration, the diode voltage at output terminal 102d is routed to V_{D1} and the diode voltage at output terminal 102c is routed to V_{D2}.

In operation, the first switching element 108 and the second switching element 110 are configured to coordinate the configurations of first switching element 108 and second switching element 110 during first and second times or phases. During first times, a first configuration of the first switching element 108 and a first configuration of the second switching element 110 are provided. During second times, a second configuration of the first switching element 108 and a second configuration of the second switching element 110 are provided. The switching elements 108 and 110 are coordinated so that a diode voltage at V_{D1} is always produced using a first of the bias currents I₁, I₂, irrespective of the one of the matching diode devices involved. Similarly, the coordination is also provided such that a diode voltage at V_{D2} is always produced using a second of the bias currents I₁, I₂, irrespective of the one of the matching diode device involved. The net effect of this coordination is that by generating the diode voltages using two different diode devices that are expected to be matched, the average difference between V_{D1} and V_{D2} may be utilized to eliminate mismatch-induced errors. This process will be explained below in further detail.

As noted above, the second switching element 110 may be configured to selectively route diode voltages at output terminals 102c, 102d from the sensing circuit 102 to provide diode voltage inputs V_{D1}, V_{D2} to at input terminals of a digital code calculation unit 112. Although the average difference between V_{D1} and V_{D2} will account for mismatch errors, as noted above, this average difference will not account for other process variation. However, as previously noted, the bandgap voltage (V_{BG}), which is a combination of the PTAT signal (diode voltage difference) and one of the diode voltage, is insensitive to temperature and has a strong correlation to the voltage difference and may be used to obtain a correction for the voltage difference. The corrected voltage difference may then be utilized to obtain the temperature.

However, obtaining the voltage difference and V_{BG} may be time-consuming in the analog domain. Accordingly, main module 104 may be configured to compute the voltage difference and V_{BG} in the digital domain using digital code calculation unit 112, which may be done significantly faster. In particular, V_{D1} and V_{D2} may be utilized with reference voltages to quickly calculate the voltage difference, V_{BG}, and temperature in the digital domain. That is, V_{D1} and V_{D2} may be combined with the two reference values, V_{R1} and V_{R2}, derived from a supply voltage V_{DD} in the digital code calculation unit 112 by using an analog to digital converter (ADC) to generate digital codes that may be utilized with a digital calibration engine to compute the temperature.

Each of the digital codes may represent a value proportional to a difference between two of V_{D1}, V_{D2}, V_{R1}, and V_{R2}. For example, a first digital code may represent a value proportional to a difference between V_{D1} and V_{D2} during a first phase for switching elements 108 and 110. A second digital code may represent a value proportional to a difference between V_{D1} and V_{D2} during a second phase for switching elements 108 and 110. A third digital code may represent a value proportional to a difference between V_{R1} and V_{R2}. A fourth digital code may represent a value proportional to a difference between V_{R1} and V_{D2} or V_{R2} and V_{D1}.

In one aspect, all the values for V_{D1}, V_{D2}, V_{R1}, and V_{R2} may be simultaneously input into digital code calculation unit 112 to generate the digital codes. In another aspect, values for V_{D1}, V_{D2}, V_{R1}, and V_{R2} may be selectively input into digital code calculation unit 112 via a series of switches, S₁ and S₂. That is, since digital code calculation unit 112 need only generate digital values representing the differences between two of V_{D1}, V_{D2}, V_{R1}, and V_{R2}, the circuitry within digital code calculation unit 112 may be configured so that only the two values for the difference need to be inputted. In such a configuration, the operation of the switches S₁, S₂ may be controlled by controller circuit 116 in conjunction with the operation of switching elements 108 and 110 so as to input the correct values needed by digital code calculation unit 112 for generating the digital codes D.

The output of digital code calculation unit 112, the digital codes Di, may then be provided to a digital calibration engine 114 to compute a calibrated temperature T_{CAL}. In one aspect, the T_{CAL} may be supplied to other components in an integrated circuit. In another aspect, the main module 104 may be configured to control such other components. Thus, the main module 104 may be configured to include a controller circuit 116. In operation, the controller circuit 116 may have logic to receive the T_{CAL} signal and generate signals for other components in an integrated circuit to address temperature concerns. These signals may be control signals, data signals, or any combination thereof.

In some aspects, digital code calculation unit 112 and/or the digital calibration engine 114 may be configured to include a chopper or other components in order to take multiple measurements of any analog values provided thereto, such as 4, 8, or 16 measurements. The actual analog value then utilized by these components may then be the average of these multiple measurements.

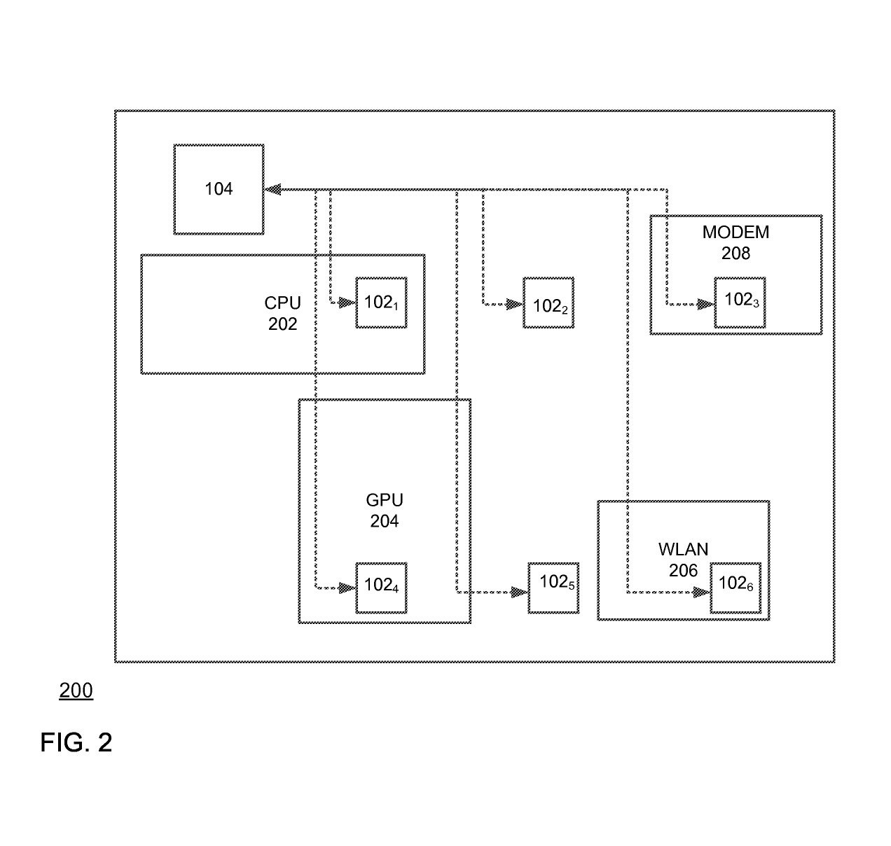

As noted above, BTS system 100 may include one or more instance of sensing circuit 102. This is illustrated with respect to FIG. 2. FIG. 2 shows an exemplary integrated circuit 200 including a BTS system. As shown in FIG. 2, integrated circuit 200 may include, but is not limited to, a central processing unit (CPU) 202, a graphics processing unit (GPU) 204, a wireless local area network (WLAN) module 206, and a modem module 208. Additionally, integrated circuit 200 may include a BTS system, such as BTS system 100 from FIG. 1, comprising a main module 104 and a plurality of sensing circuits 102₁, 102₂, 102₃, 102₄, 102₅, and 102₆.

In operation the main module 104 may selectively couple to each of sensing circuits 102₁-102₆ to obtain calibrated temperature measurements across the integrated circuit 200. If a calibrated temperature associated with one or more of the sensing circuits 102₁-102₆ indicates that a hot spot or other undesirable temperature deviation is present, appropriate action may be taken. In one aspect, as discussed above, the controller circuit 116 within main module 104 may communicate with any of components 202-208 of integrated circuit 200 in order to address the undesired temperature deviation. For example, in some aspects the main module 104 can generate instructions for the other components. In another aspect, the main module 104 can be configured to generate a flag, interrupt or other signal or value monitored by the other components used by such components to trigger some action. Such actions include, but are not limited to, reducing a voltage within or provided by a component or reducing a clock frequency within or provided by a component. In still another aspect, the main module 104 may provide the calibrated temperature to one or more of the components 202-208 and such components may include logic for detecting undesired temperature deviation and/or taking appropriate action.

Referring back to FIG. 1, in order to provide the main module 104 access to multiple instances of sensing circuit 102, additional circuitry may be provided to select among the different instances of sensing circuit 102. For example, as shown in FIG. 1, an input multiplexer (MUX IN) 118 and an output multiplexer (MUX OUT) 120 may be provided. In operation, the MUX IN 118 and MUX OUT 120 may be configured to couple input terminal 102a, 102b and output terminal 102c, 102d of a selected sensing circuit 102 to the main module 104. In one aspect, MUX IN 118 and MUX OUT 120 may be pre-programmed to cycle through the instances of sensing circuit 102 in a pre-defined order. In another aspect, the controller circuit 116 or other component may be configured to control operation of MUX IN 118 and MUX OUT 120. Additionally or alternatively, the controller circuit 116 may also be configured to coordinate operation of the switching elements 108 and 110. That is, to synchronize the configurations of the switching elements 108 and 110 as discussed above.

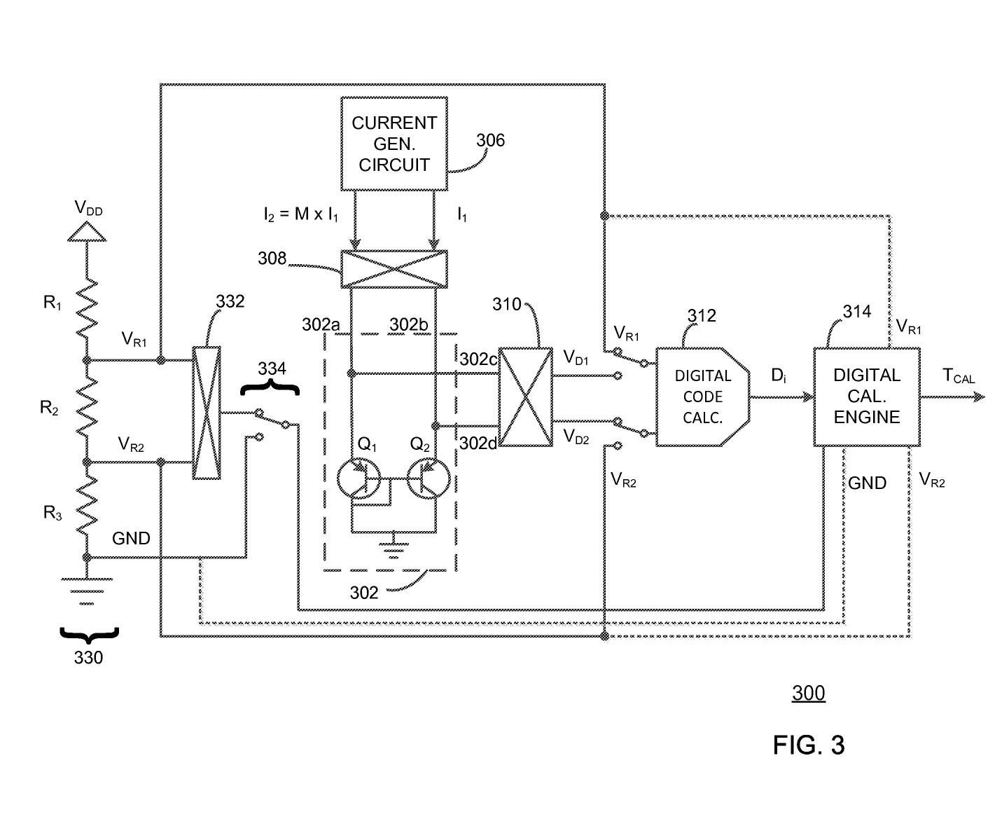

As noted above, the sensing circuit may be implemented using a variety of diode devices. However, for purposes of illustration, the disclosure turns to a more detailed description for implementing the BTS system using BJTs, as shown in FIG. 3.

FIG. 3 shows an exemplary BTS system circuit 300 according to one aspect. Similar to the BTS system of FIG. 1, the circuit 300 includes a sensing circuit 302, a current generating circuit 306, a first switching circuit 308, a second switching circuit 310, a digital code calculation unit 312, and a digital calibration engine 314. Accordingly, except where noted below, the description of the corresponding components in FIG. 1 is sufficient for describing these components of FIG. 3.

As shown in FIG. 3, the sensing circuit 302 may include a pair of PNP BJTs, Q₁ and Q₂, in effectively a current sourcing configuration. That is, the collector and base of each of BJTs Q₁ and Q₂ are tied to ground while the emitters of each of BJTs Q₁ and Q₂ are tied to a current source. In the case of FIG. 3, the emitter of Q₁ is coupled to input terminal 302a to receive a first bias current and the emitter of Q₂ is coupled to input terminal 302b to receive a second bias current.

In the case of sensing circuit 302, the diode voltage for each of Q₁ and Q₂ is the base-emitter voltage (V_{BE}). Therefore, as the base of each of Q₁ and Q₂ is tied to ground, the voltage at the emitter of Q₁ and Q₂ provides corresponding values for V_{BE}.

As previously noted, switching element 308 is configured to operate in first and second configurations to route currents I₁ and I₂ from current generating circuit 306 to BJTs Q₁ and Q₂. In a first configuration, current I₂ is provided to the emitter of BJT Q₁ and current I₁ is provided to the emitter of BJT Q₂. In a second configuration, current I₁ is provided to the emitter of BJT Q₁ and current I₂ is provided to the emitter of BJT Q₂. Similarly, switching element 310 is configured to operate in first and second configurations to provide voltages at the emitter nodes of BJTs Q₁ and Q₂ at V_{D1} and V_{D2}. In a first configuration, the diode voltage at the emitter of BJT Q₁ is provided to V_{D1} and the diode voltage the emitter of BJT Q₂ is provided to V_{D2}. In a second configuration, the diode voltage at the emitter of BJT Q₁ is provided to V_{D2} and the diode voltage the emitter of BJT Q₂ is provided to V_{D1}. As also noted above, the switching element 310 is configured to operate in a coordinated fashion with switch element 308 so that switching element 308 is in a first configuration when switching element 310 is in a first configuration and switching element 308 is in a second configuration when switching element 310 is in a second configuration

Therefore, when the first switching element 308 and the second switching element 310 are both in their first configurations, bias current I₂ is routed to BJT Q₁ and bias current I₁ is routed to BJT Q₂. Concurrently, the diode voltage for BJT Q₁ provided at output terminal 302c is routed to provide V_{D1} to the digital code calculation unit 312 and the diode voltage associated with BJT Q₂ provided at 302d, is routed to provide V_{D2} to the digital code calculation unit 312. In contrast, when the first switching element 308 and the second switching element 310 are both in their second configurations, bias current I₁ is routed to BJT Q₁ and bias current I₂ is routed to BJT Q₂. Concurrently, the diode voltage for BJT Q₁ provided at output terminal 302c, is routed to provide V_{D2} to the digital code calculation unit 312 and the diode voltage associated with BJT Q₂ provided at 302d, is routed to provide V_{D1} to the digital code calculation unit 312.

In the case of FIG. 3, the net effect of this coordinated operation of the first switching element 308 and the second switching element 310 is that V_{D1} receives a diode voltage that is a function of I₁, regardless of configuration of switching elements 308 and 310, while V_{D2} receives a diode voltage that is a function of I₂, regardless of the configuration of the switching elements 308 and 310. Thus, during each phase a ΔV_{BE} may be obtained, where ΔV_{BE} is the difference between V_{BE} of Q₁ and V_{BE} of Q₂. In one phase, ΔV_{BE} can be the ΔV_{BE} of Q₁ minus the ΔV_{BE} of Q₂. In the other phase, ΔV_{BE} can be the ΔV_{BE} of Q₂ minus the ΔV_{BE} of Q₂. Thereafter, the two values of ΔV_{BE} may then be averaged to obtain the final ΔV_{BE}, which removes the error due to any mismatch between Q₁ and Q₂.

Although the average ΔV_{BE} that is obtained from sensing circuit 302 will account for mismatch errors, the average ΔV_{BE} will not account for other process variations. However, as noted above the bandgap voltage is insensitive to temperature and has a strong correlation to ΔV_{BE}. Thus, V_{BG} may be utilized to produce a corrected ΔV_{BE}(ΔV_{BE}_{_}_{corr}) as follows:

ΔV_{BE}_{_}_{corr}=ΔV_{BE}−(k·V_{BG}+c). (1)

where k and c are the slope and intercept, respectively, for a pre-defined linear correlation between ΔV_{BE} and V_{BG}. The pre-defined linear correlation may be determined a priori for a particular technology via characterization of devices fabricated using the particular technology. The corrected ΔV_{BE} may then be utilized to obtain the temperature.

However, as noted above, obtaining V_{BG} and differences in diode voltages may be time-consuming in the analog domain. Accordingly, as in FIG. 1, the circuit of FIG. 3 is configured to compute ΔV_{BE} and V_{BG} in the digital domain, which may be done significantly faster. In particular the output of the sensing circuit 302 may be utilized by the digital code calculation unit 312 and digital calibration engine 314, with reference voltages V_{R1} and V_{R1}, to quickly calculate ΔV_{BE}, V_{BG}, and a calibrated temperature in the digital domain.

As discussed above, with respect to FIG. 1, the diode voltage values, i.e., the V_{BE} values, from sensing circuit 302 may be combined with the two reference voltages V_{R1} and V_{R2} via digital code calculation unit 312. In particular, digital code calculation unit 312 may include an analog to digital converter (ADC) to generate the digital codes Dᵢ that may be utilized with the digital calibration engine 314 to compute the temperature.

In one aspect, the digital codes generated at the digital code calculation unit 312 may consist of certain difference values between the inputs thereto. In particular, the difference between V_{BE} values during a first phase or times, i.e., first configurations, for the switching elements 308 and 310 (D_{ΔVBE1}), the difference between the V_{BE} values during a second phase or times, i.e., second configurations, for the switching elements 308 and 310 (D_{ΔVBE2}), the difference between V_{R1} and V_{R2} (D_{ΔVR}), and the difference between V_{R1} and one of the V_{BE} values (D_{VR1-VBE}). These difference values in the digital domain are related to values in the analog domain as follows:

D_{ΔVBE1}=ΔV_{BE}_{_}_{Phase1}/V_{ref}; (2)

D_{ΔVBE2}=ΔV_{BE}_{_}_{Phase2}/V_{ref}; (3)

D_{ΔVR}=(V_{R1}−V_{R2})/V_{ref}; and (3)

D_{VR1-VBE}=(V_{R1}−V_{BEi})/V_{ref}. (4)

In the equations above, ΔV_{BE}_{_}_{Phase1} is the difference between V_{BE} values during a first phase or times, ΔV_{BE}_{_}_{Phase2} is the difference between V_{BE} values during a second phase or times, V_{R1} is the first reference voltage, V_{R2} is the second reference voltage, V_{BEi} is one of the two diode voltages, and V_{ref} is the reference voltage for the ADC.

The digital codes may then be input into the digital calibration engine 314, which in turn calculates ΔV_{BE} between Q₁ and Q₂, V_{BG}, and the calibrated temperature (T_{CAL}). For example, ΔV_{BE} may be computed based on a combination of equations (2), (3), and (4) as follows:

$$Δ {V}_{BE} = Δ {V}_{R} \frac{( {D}_{Δ VBE 1} - {D}_{Δ VBE 2} )}{2 {D}_{VR}} \qquad ( 5 )$$

where ΔV_{BE} is the average ΔV_{BE} for the two phases or times and ΔV_{R} is the difference between V_{R1} and V_{R2}. The error in ΔV_{BE} due to device mismatch is minimized here.

V_{BE} may computed based on a combination of equations (3) and (4) as follows:

$${V}_{BE} = {V}_{R 1} - Δ {V}_{R 1} \frac{{D}_{VR 1 - VBE}}{{D}_{VR}} \qquad ( 6 )$$

Based on equations (5) and (6), V_{BG} may then be computed as:

V_{BG}=V_{BE}+mΔV_{BE} (7)

wherein m is a constant value, obtained from characterization of the integrated circuit, to realize temperature insensitive bandgap voltage.

Finally, the corrected ΔV_{BE} may be obtained using the computed ΔV_{BE} and V_{BG} values as:

ΔV_{BE}_{_}_{corr}=ΔV_{BE}−(k·V_{BG}+c), (8)

where k and c are the slope and intercept of the correlation equation for ΔV_{BE} and V_{BG}. These may be derived from characterization. The error in ΔV_{BE} due to process variation is minimized here.

Once the corrected ΔV_{BE} is obtained, the digital calibration engine may then proceed to compute the calibrated temperature. In particular, the calibrated temperature is related to the corrected ΔV_{BE} value by:

T_{CAL}=a×ΔV_{BE}_{_}_{corr}b, (9)

where a and b are known constants or constants that may be derived from measurements to convert the ΔV_{BE}_{_}_{corr} to temperature. The values for a and b can be determined a priori via measurements of devices fabricated using the same process technology at a plurality of known temperatures.

It should be noted that the equations presented above are based on the configuration of components shown in FIG. 3. Accordingly, the present disclosure contemplates that for other configurations of a sensing circuit, the equations described above may vary.

As discussed above, the calculation of the calibrated temperature is dependent on reference voltages V_{R1} and V_{R2}. Such reference voltages may be generated from V_{DD} in any manner. In one aspect, multiple, independent voltage sources may be provided to supply V_{R1} and V_{R2}. In another aspect, as shown in FIG. 3, a voltage divider circuit 330 may be used to derive V_{R1} and V_{R2} from V_{DD}. That is, as shown in FIG. 3, the voltage divider 330 is configured to include resistors R₁, R₂, and R₃, in series between V_{DD} and ground. V_{R1} may then be taken from a node between R₁ and R₂ and V_{R2} may be taken from a node between R₂ and R₃. It should be noted that reference voltages V_{R1} and V_{R2} in FIG. 3 may be expected to be stable, as resistors R₁, R₂, and R₃ are not expected to be sensitive to mismatch with careful layout, even at smaller semiconductor process nodes.

However, to ensure accurate temperature values from the digital calibration engine 314, V_{R1} and V_{R2} may be provided to the digital calibration engine 314 (as shown by the dotted lines in FIG. 3, along with other reference values, such as the ground node of the voltage divider circuit 330. For example, as shown in FIG. 3, the voltages for V_{R1} and V_{R2}, along with the associated ground voltage may be supplied to the digital calibration engine 314 via an analog input channel. As shown in FIG. 3, such an input channel may include a third switching circuit 332 provided to select between one of V_{R1} and V_{R2} to be provided directly to the digital calibration engine 314. Optionally, the analog input channel may also include a fourth switching circuit 334 to supply the ground reference voltage associated with V_{R1} and V_{R2}. The digital calibration engine 314 may then use V_{R1} and V_{R2}, alone or in combination with the ground reference voltage, to determine temperature. In some aspects, the digital calibration engine 314 may be configured to include a buffer, a chopper, and/or other components in order to take multiple measurements of V_{R1}, V_{R2}, and ground reference voltage, such as 4, 8, or 16. The actual value then utilized by the digital calibration engine 314 may be the average of these multiple measurements.

Although FIG. 3 illustrates certain components and a particular arrangement thereof, it should be understood that this is solely for ease of illustration and description. Thus, the disclosure contemplates that in some aspects, more or less components than shown in FIG. 3 may be provided. Similarly, the disclosure also contemplates that other components than shown in FIG. 3 may be provided. For example, it should be understood that a controller circuit, as discussed above with respect to FIG. 1, may be provided to control and coordinate the operation of any of the components shown in FIG. 3. In another example, it should be understood that multiplexer circuits, as discussed above with respect to FIG. 1, may be provided to access multiple instances of the sensing circuit 302.

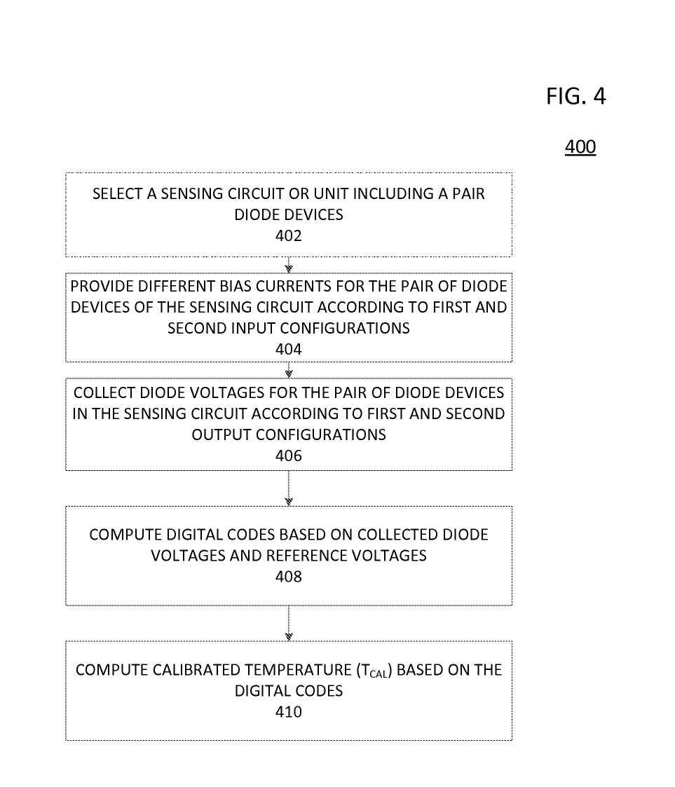

Now turning to FIG. 4, there is shown a flowchart of blocks in exemplary method 400 for computing a calibrated temperature using, for example, either of the configurations illustrated in FIGS. 1 and 3. The method 400 may optionally begin at block 402 with the selection of a sensing circuit, if multiple instances of the sensing circuit are present in the integrated circuit. In one aspect, this may involve, as discussed above with respect to FIG. 1, the operation of multiplexers 118 and 120 to couple the main module 104 to one of sensing circuits 102. However, in other aspects, only a single sensing circuit may be provided in the integrated circuit.

Next, at block 404, first and second different currents are provided to the selected sensing circuit for the pair of diode devices therein according to first and second configurations. As discussed above, this may involve the generation of I1 and I2 using the current generating circuit 106, as discussed above with respect to FIG. 1, and the routing of the currents to the input terminals 102a, 102b of the sensing circuit 102. As also discussed above with respect to FIG. 1, the routing may involve configuring the first switching circuit 108 to operate according one of a first or a second configuration to selectively route I1 and I2 to input terminals 102a and 102b, respectively, or to input terminals 102b and 102a, respectively. The routing may also involve providing the controller circuit 116 to cause the first switching circuit 108 to alternate between the first and the second configuration during the different times or phases.

As the different currents are provided at block 404 to the sensing circuit, the diode voltages for the pair of diodes may be obtained or collected or routed at block 406. As discussed above with respect to FIG. 1, this may involve coordinating the operation of the second switching circuit 110 with the operation of the first switching circuit 108 via controller circuit 116 or some other component. As also noted above, the routing of diode voltages may also involve utilizing one or more components to collect multiple measurements of each diode voltage and thereafter averaging such multiple measurements before utilizing them for any subsequent calculations of ΔV_{BE}, V_{BE}, V_{BG}, or T_{CAL}.

Following block 406, the collected diode voltages may be combined with reference voltages to compute digital codes at block 408. As discussed above with respect to FIG. 3, this may involve converting the diode voltages into the digital domain and computing digital codes representing differences between the diode voltages during different phases, differences between the reference voltages, and differences between one of the reference voltages and one of the diode voltages. Finally, at block 410, the digital codes may be utilized to compute a calibrated temperature. As discussed above, this can involve receiving the digital codes from the digital code calculation unit 112 and receiving any reference voltages via an analog input channel.

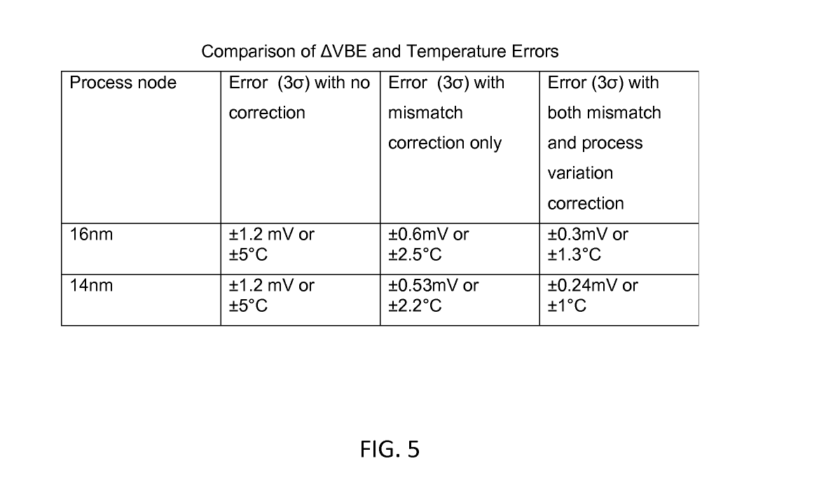

The methodologies described above have been tested and shown to provide significantly improved temperature measurements at small semiconductor process nodes, as shown below in the table in FIG. 5. FIG. 5 is a table showing ΔV_{BE} and temperature errors for two exemplary semiconductor process nodes, 16 nm and 14 nm.

The data in FIG. 5 is provided solely for illustrative purposes and should not be interpreted as limiting the scope of the present disclosure in any regard. The data in FIG. 5 shows the effect of providing no correction mechanisms (i.e., a conventional temperature sensing circuit), providing only mismatch correction mechanisms (i.e., providing the switching elements for the sensing circuit—to remove errors due to transistor mismatch), and providing both mismatch and process variation correction mechanisms (i.e., the switching elements for the sensing circuit and the digital calibration engine—to remove errors due to transistor mismatch and to provide correction of ΔV_{BE}). As shown in FIG. 5, providing no type of correction mechanism for either mismatch or process variations results in ΔV_{BE} errors greater and lmV, corresponding to temperature measurement errors of up to 5° C. As noted above, such a degree of error would require a significant guardband to avoid damaging the integrated circuit.

However, as also shown in FIG. 5, simply providing mismatch correction significantly reduces error. In particular, the error is reduced from 5° C. to 2.5° C. and 2.2.° C. for the 16 nm and 14 nm technologies, respectively. While this error reduction amounts to a 50% improvement, the guardband that may be required for such errors (˜2.5° C.) may still be significant for certain applications. As discussed above, further improvement is obtained by providing both mismatch and process variation correction, as discussed above. Referring back to FIG. 5, FIG. 5 shows that incorporating both types of correction causes error to be reduced from 5° C. to 1.3° C. and 1.0° C. for the 16 nm and 14 nm technologies, respectively. This is a 75% to 80% reduction in error. As a result, only a relatively small guardband (˜1-1.5° C.) would be needed. Consequently, the likelihood that inappropriate action will be taken due to a temperature measurement is significantly reduced, as the temperature errors are severely curtailed.

In some aspects, the methodology described may be used to efficiently calculate a calibrated temperature. However, in other aspects, the methodology described above may be streamlined to provide a calibrated sensor in which temperature may be determined directly from ΔV_{BE}. In particular, this involves recognizing that the calibrated temperature may be alternatively expressed as:

$${T}_{cal} = \frac{D - {D}_{To}}{s} + {T}_{0} \qquad ( 10 )$$

where T₀ is a calibration temperature (e.g., 30° C.), D is the digital code for ΔV_{BE} at T_{CAL}, D_{To} is the digital code for ΔV_{BE} at the calibration temperature T₀, and s is the slope of the line correlating the digital codes for ΔV_{BE} to temperature.

The calibration process may start first with obtaining the slope s. This may involve performing the method of FIG. 4 multiple times at multiple temperatures to obtain data for ΔV_{BE} versus temperature. Based on this data, s may be derived and stored for future use. The calibration process then requires obtaining D_{To} for a desired T₀. This may involve obtaining ΔV_{BE}_{_}_{corr} (which itself involves obtaining ΔV_{BE} and V_{BG} as discussed above) at room temperature or some other convenient temperature. It should be noted that s may vary as a function of temperature somewhat, so in some aspects, the temperature for the calibration may be selected to be close to the temperatures likely to be measured. The calibrated temperature is then back calculated. Using the calibrated temperature, s, and the digital value for ΔV_{BE}_{_}_{corr}, D_{To} may be obtained by rearranging equation (10) to:

D_{To}=D_{ΔVBE}−s·(T_{CAL}−T₀) (11)

D_{To} may then be stored for future use, along with the selected value for T₀. In a “mission” mode, a digital value for ΔV_{BE}_{_}_{corr} may then be obtained and used with the stored values and equation (10) to obtain the calibrated temperature.

Although the present technology has been illustrated and described with respect to one or more implementations, equivalent alterations and modifications will occur to others skilled in the art upon the reading and understanding of this specification and the annexed drawings. In addition, while certain features of the disclosure may have been disclosed with respect to only one of several implementations, such feature may be combined with one or more other features of the other implementations as may be desired and advantageous for any given or particular application.

For example, those skilled in the art would appreciate that the various illustrative logical blocks, modules, circuits, and other blocks described in connection with the disclosure herein may be implemented as electronic hardware, computer software, or combinations of both. To clearly illustrate this interchangeability of hardware and software, various illustrative components, blocks, modules, circuits, and other blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Further, the various illustrative logical blocks, modules, and circuits described in connection with the disclosure herein may be implemented or performed within a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

The terminology used herein is for the purpose of describing particular aspects of the disclosure is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. Also, the terms “about”, “substantially”, and “approximately”, as used herein with respect to a stated value or a property, are intend to indicate being within 20% of the stated value or property, unless otherwise specified above. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A temperature sensor, comprising:
a sensing circuit comprising first and second matching diode devices configured to providing first and second diode voltages proportional to currents through the first and the second matching diode devices, respectively;
a digital code calculation unit comprising first and second diode voltage input terminals, the digital code calculation unit configured to generating a plurality of digital code values based on first and second reference voltages and voltages at the first and the second diode voltage input terminals;
a first switching circuit configured to routing the first and the second diode voltages, during first times, to the first and the second diode voltage input terminals, respectively, and routing the first and the second diode voltages, during second times, to the second and the first diode input voltage terminals, respectively; and
a digital calibration engine configured to compute a calibrated temperature based on the plurality of digital code values.

2. The sensor of claim 1, wherein the sensing circuit further comprises first and second input terminals associated with the first and the second matching diode devices, respectively, and further comprising:
a second switching element configured to route first and second bias currents into the first and the second input terminals, respectively, during the first times, and routing the first and the second bias currents into the second and the first input terminals, respectively, during the second times.

3. The sensor of claim 2, further comprising a current generating circuit configured to provide the first bias current and the second bias current.

4. The sensor of claim 3, wherein the current generating circuit is configured to cause the second bias current to be a multiple of the first bias current.

5. The sensor of claim 1, wherein the first and the second matching diode devices comprise matched first and second bipolar junction transistors, respectively, and wherein the first and the second diode voltages each comprise a base-emitter voltage of each of the matching first and second bipolar junction transistors, respectively.

6. The sensor of claim 1, wherein the first switching circuit comprises a dynamic element matching circuit.

7. The sensor of claim 1, further comprising a voltage divider circuit configured to generate the first and the second reference voltages.

8. The sensor of claim 1, wherein the plurality of digital codes comprises a first digital code representing a value proportional to a difference between the first and the second diode voltages during the first time, a second digital code representing a value proportional to a difference between the first and the second diode voltages during the second time, a third digital code representing a value proportional to a difference between the first and the second reference voltages, and a fourth digital code representing a value proportional to a difference between the first reference voltage and the second diode voltage.

9. A method for sensing temperature comprising:
providing first and second bias currents to first and second matched diode devices of a sensing circuit according to a first input configuration during first times and according to a second input configuration during second times;
obtaining first and second diode voltages to the first and the second matched diode devices according to a first output configuration during first times and according to a second output configuration during second times;
generating a plurality of digital codes based on the first and the second diode voltages, during the first times and the second times, and based on first and second reference voltages; and
computing a calibrated temperature based on the plurality of digital codes.

10. The method of claim 9, wherein the sensing circuit comprises first and second input terminals corresponding to the first and the second matching diode devices, respectively, wherein the first input configuration comprises routing the first and the second bias current to the first and the second input terminals, respectively, wherein the second input configuration comprises routing the first and the second bias current to the second and the first input terminals, respectively.

11. The method of claim 9, wherein the sensing circuit comprises first and second output terminals corresponding to the first and the second matching diode devices, respectively, wherein the first output configuration comprises routing the first and the second diode voltages to the first and the second output terminals, respectively, and wherein the second output configuration comprises routing the first and the second diode voltages to the second and the first output terminals, respectively.

12. The method of claim 9, wherein the generating of the plurality of digital codes comprises computing a first digital code representing a value proportional to a difference between the first and the second diode voltages during the first time, a second digital code representing a value proportional to a difference between the first and the second diode voltages during the second time, a third digital code representing a value proportional to a difference between the first and the second reference voltages, and a fourth digital code representing a value proportional to a difference between the first reference voltage and the second diode voltage.

13. The method of claim 9, wherein the first and the second matched diode devices comprise matched first and second bipolar junction transistors, respectively, and wherein the first and the second diode voltages each comprise a base-emitter voltage of each of the matched first and second bipolar junction transistors, respectively.

14. The method of claim 9, wherein providing the first and the second bias current comprises selecting the second bias current to be a multiple of the first bias current.

15. The method of claim 9, further comprising generating the first and the second reference voltages using a voltage divider.

16. An apparatus configured to sensing temperature, comprising:
means configured to providing first and second bias currents configured to first and second matching diode devices of a sensing circuit according to a first input configuration during first times and according to a second input configuration during second times;
means configured to obtaining first and second diode voltages configured to the first and the second matching diode devices according to a first output configuration during first times and according to a second output configuration during second times;
means generating a plurality of digital codes based on the first and the second diode voltages, during the first times and the second times, and first and second reference voltages; and
means configured to computing a calibrated temperature based on the plurality of digital codes.

17. The apparatus of claim 16, wherein the sensing circuit comprises first and second input terminals configured to the first and the second matching diode devices, respectively, wherein the first input configuration comprises routing the first and the second bias current to the first and the second input terminals, respectively, wherein the second input configuration comprises routing the first and the second bias current to the second and the first input terminals, respectively.

18. The apparatus of claim 16, wherein the sensing circuit comprises first and second output terminals configured to the first and the second matching diode devices, respectively, wherein the first output configuration comprises routing the first and the second diode voltages to the first and the second output terminals, respectively, and wherein the second output configuration comprises routing the first and the second diode voltages to the second and the first output terminals, respectively.

19. The apparatus of claim 15, wherein the plurality of digital codes comprises a first digital code representing a value proportional to a difference between the first and the second diode voltages during the first time, a second digital code representing a value proportional to a difference between the first and the second diode voltages during the second time, a third digital code representing a value proportional to a difference between the first and the second reference voltages, and a fourth digital code representing a value proportional to a difference between the first reference voltage and the second diode voltage.

20. An integrated circuit comprising:
a plurality of sensing circuits, each of the plurality of sensing circuits comprising first and second matching diode devices and configured to provide first and second diode voltages proportional to current through the first and the second matching diode devices, respectively; and
a main module configured to selectively access any one of the plurality of sensing circuits to yield a selected sensing circuit, the main module comprising:
a digital code calculation unit comprising first and second diode voltage input terminals and configured to generate a plurality of digital codes based on the first and the second diode voltages of the selected sensing circuit,
a first switching circuit configured to route the first and the second diode voltages of the selected sensing circuit to the first and the second diode voltage input terminals during first times, respectively, and configured to routing the first and the second diode voltages of the selected sensing circuit to the second and the first diode voltage input terminals during second times, respectively, and
a digital calibration engine configured to compute a calibrated temperature at the selected sensing circuit based on the plurality of digital codes.

21. The integrated circuit of claim 20, wherein the main module further comprises at least one multiplexer circuit configured to couple the main module to the selected sensing circuit.

22. The integrated circuit of claim 20, wherein the selected sensing circuit further comprises first and second input terminals associated with the first and the second matching diode devices, respectively, and wherein the main module further comprises:
a second switching element configured to routing first and second bias currents into the first and the second input terminals, respectively, during the first times, and routing the first and the second bias currents into the second and the first input terminals, respectively, during the second times.

23. The integrated circuit of claim 20, wherein the main module further comprises a current generating circuit configured to provide the first and the second bias currents.

24. The integrated circuit of claim 23, wherein the current generating circuit is configured to cause the second bias current to be a multiple of the first bias current.

25. The integrated circuit of claim 20, wherein the first and the second matching diode devices comprise first and second matching bipolar junction transistors, and wherein the first and the second output voltages each comprise a base-emitter voltage.

26. The integrated circuit of claim 20, wherein the first switching circuit comprises a dynamic element matching circuit.

27. The integrated circuit of claim 20, the processing module further comprising a voltage divider circuit configured to generate the first and the second reference voltages.

28. The integrated circuit of claim 20, wherein the plurality of digital codes comprises a first digital code representing a value proportional to a difference between the first and the second diode voltages during the first time, a second digital code representing a value proportional to a difference between the first and the second diode voltages during the second time, a third digital code representing a value proportional to a difference between the first and the second reference voltages, and a fourth digital code representing a value proportional to a difference between the first reference voltage and the second diode voltage.
